(19) United States
(12) Patent Application Publication
(10) Pub. No.: US 2007/0177616 A1
(43) Pub. Date: Aug. 2, 2007

(54) INTERACTIVE MULTIMEDIA EXCHANGE ARCHITECTURE AND SERVICES

(75) Inventors: Marwan A. Jabri, Tiburon, CA (US); Brody Kenrick, San Francisco, CA (US); David Jack, Berkshire (GB); Albert C. Wong, Rohnert Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dilithium Networks Pty Ltd., Broadway (AU)

(21) Appl. No.: 11/622,951

(22) Filed: Jan. 12, 2007

Related U.S. Application Data
(60) Provisional application No. 60/758,749, filed on Jan. 13, 2006.

(51) Int. Cl. H04L 12/56

(52) U.S. Cl. 370/401

(57) ABSTRACT

A multimedia exchange server adapted to communicate multimedia information includes a multimedia gateway adapted to receive a first media from a first network and transmit a second media to a second network. The multimedia exchange server also includes a processor coupled to the multimedia gateway and adapted to provide the second media. The multimedia exchange server further includes a memory coupled to the processor and adapted to store the first media. The first media is stored in the memory for a predetermined period of time, which is greater than a buffering period.

### CROSS-REFERENCES TO RELATED APPLICATIONS

The present application claims the benefit under 35 U.S.C. §119(e) of U.S. Provisional Patent Application No. 60/758,749, filed on Jan. 13, 2006, entitled “Multimedia Exchange Architecture and Services,” which is incorporated herein by reference in its entirety.

The following three regular U.S. patent applications (including this one) are being filed concurrently, and the entire disclosures of the other applications are incorporated by reference into this application for all purposes:
Application No.______ , filed Jan. 12, 2007, entitled “Interactive Multimedia Exchange Architecture and Services” (Attorney Docket No. 021318-005010US);
Application No.______ , filed Jan. 12, 2007, entitled “Multimedia Content Exchange Architecture and Services” (Attorney Docket No. 021318-005020US); and
Application No.______ , filed Jan. 12, 2007, entitled “Multimedia Streaming and Gaming Architecture and Services” (Attorney Docket No. 021318-005030US).

### BACKGROUND OF THE INVENTION

This invention concerns the field of telecommunications, and particularly addresses digital multimedia communications. Present networks such as Third Generation (3G) mobile and broadband cable, DSL, WiFi, and WiMax networks allow their users access to a rich complement of multimedia services including audio, video and data.

The Third Generation Partnership Project (3GPP) is an industry consortium formed to advance the technology and acceptance of 3G mobile networks (and further networks which are sometimes characterized as 3.5G or 4G, with capabilities exceeding those specified as 3G, but still referred to as 3G, or at least 3G). The 3GPP has defined the 3G-324M Technical Specification that defines how terminals and the network interoperate in order to provide advanced services.

The 3G-324M Technical Specification is based on the ITU-T (International Telecommunication Union, Telecommunication Standardization Sector) H.324 Standard, that is, 3G-324M can be seen as a specific configuration of the H.324 Standard of the ITU-T.

The 3GPP 3G-324M recommendations use and extend H.324 as follows:
1. The use of the ITU-T H.324 umbrella recommendation and its Annex C. This defines the overall videotelephony service, including H.223 and H.245 from ITU-T.
2. The use of Annexes A and B of H.223.
3. The use of the mobile messaging facilities of H.245.
4. The use of specific audio and video codecs. For example, the GSM-AMR audio codec and the H.263 video codec are recommended. Other audio and video codecs are proposed as options.

The 3GPP defines a phased network evolution and has defined specifications for “Release 99,” “Release 5,1” and “Release 6” networks in a logical network migration. 3GPP continues work on future releases such as “Release7” and “Release8.” Most mobile/wireless networks today use circuit switched interfaces and protocols (e.g., ISDN, ISUP, and TDM DSOs) in order to connect to fixed network telephony subscribers. Plans for future networks call for the use of packet switched interfaces and protocols (e.g., SIP over the IMS packet network or the Internet over IPv4 or IPv6). Intermediate networks between fully CS and PS may use technology such as SIP-I/Q.1912.5/RFC4040 to allow for the use of the data from 3G CS devices in an IP network, allowing simplification of the network core migration ahead of 3G IP terminal roll out.

Although there are many protocols that govern access to broadband networks such as cable, DSL, WiMax, WiFi, and HSDPA, it is accepted today that users access a multitude of services over broadband using the Internet Protocol (IP), regardless of the underlying access technologies.

One can generally group the transport of multimedia to be either through a circuit-switched or a packet-switched network. Examples of circuit-switched access are the 3GPP 3G-324M over ISDN, or the PSTN. An example of packet-switched access includes 3G packet bearer, HSDPA and/or HSUPA, Cable, WiFi, WiMax, and DSL.

The widely disparate types of networks and protocols employed further coupled with the vastly differing capabilities of the devices employed on those networks (even internally on those networks) creates many barriers to the ease of sharing information material among users and between users devices. Users will have the growing expectation that their material will be accessible by whomever they desire and on whatever device the second party chooses to use for retrieval and with some particular access network characteristics.

The typical user desires that their media be seamlessly accessible by another user as well as to multiple differing clients with varied capabilities and access technologies and protocols in a fashion that is transparent to them. It is believed that these desires will need to be met in order to successfully deliver revenue generating services. The augmentation of networks, such as 3G-324M, that are presently capable of telephony services but not sharing services is one such example.

Thus, there is a need in the art for improved methods and systems for receiving and transmitting multimedia information over disparate advanced networks, and in particular advanced capability networks such as 3G/3GPP networks and wireless IP networks that allow for information exchange between devices using those networks.

### SUMMARY OF THE INVENTION

According to an embodiment of the present invention, a method of communicating media using a multimedia terminal is provided. The method includes receiving, at a multimedia exchange server, a request to establish a communication link between the multimedia terminal and the multimedia exchange server and establishing the communication link between the multimedia terminal and the multimedia exchange server. The method also includes receiving, at the multimedia exchange server, a first media stream from the multimedia terminal and transmitting a second media stream from the multimedia exchange server to a device. The method further includes transmitting an interactive menu from the multimedia exchange server to the multimedia terminal and receiving, at the multimedia terminal, one or more user inputs in response to the interactive menu. The multimedia exchange is responsive to the one or more user inputs.

According to another embodiment of the present invention, a multimedia exchange server adapted to communicate multimedia information is provided. The multimedia exchange server includes a multimedia gateway adapted to receive a first media from a first network and transmit a second media to a second network and a processor coupled to the multimedia gateway and adapted to provide the second media. The multimedia exchange server also includes a memory coupled to the processor and adapted to store the first media. The first media is stored in the memory for a predetermined period of time, which is greater than a buffering period.

According to yet another embodiment of the present invention, a method of communicating media using a 3G-324M terminal is provided. the method includes receiving, at a multimedia exchange server, a request to establish a communication link between the 3G-324M terminal and the multimedia exchange server and establishing the communication link. The method also includes establishing a media session between the 3G-324M terminal and the multimedia exchange server, receiving, at the multimedia exchange server, a first media stream from the 3G-324M terminal, and transcoding, at the multimedia exchange server, the first media stream to provide a second media stream. The method further includes storing, at the multimedia exchange server, the second media stream, determining, at the multimedia exchange server, that an event has occurred to initiate transmission of the second media stream, and transmitting the second media stream to a device.

According to an alternative embodiment of the present invention, a method of providing media from a video terminal to an IP-based video sharing portal is provided. The method includes establishing a video call between the video terminal and a multimedia exchange server and establishing a media session between the video terminal and the multimedia exchange server. The method also includes receiving a first media stream transmitted from the video terminal to the multimedia exchange server, processing the first media stream to provide a media file capable of being transmitted to the IP-based video sharing portal, and storing the media file at the multimedia exchange server. The method further includes determining user account information for the IP-based video sharing portal based, in part, on one or more characteristics of the video call and transmitting the media file from the multimedia exchange server to the IP-based video sharing portal utilizing the user account information.

According to another alternative embodiment of the present invention, a method of providing media and associated meta-information from a user sharing media from a video terminal to an IP-based video sharing portal is provided. The method includes establishing a video call between a video terminal and a multimedia exchange server, establishing a media session between the video terminal and the multimedia exchange server, and receiving a first media stream transmitted from the video terminal to the multimedia exchange server. The method also includes receiving, at the multimedia exchange server, one or more pieces of meta-information associated with the video terminal, processing the first media stream to provide a media file capable of being transmitted to the IP-based video sharing portal, and storing the media file at the multimedia exchange server. The method further includes storing the one or more pieces of meta-information at the multimedia exchange server and transferring the media file and the one or more pieces of meta-information from the multimedia exchange server to the IP-based video sharing portal.

According to yet another alternative embodiment of the present invention, a method of managing media on a multimedia exchange server using a multimedia terminal is provided. The method includes receiving, at a multimedia exchange server, a request to establish a communication link between the multimedia terminal and the multimedia exchange server and establishing the communication link between the multimedia terminal and the multimedia exchange server. The method also includes transmitting a content management menu from the multimedia exchange server to the multimedia terminal. The content management menu includes one or more options for managing content on the multimedia exchange server. Additionally, the multimedia exchange server is adapted to respond to a receipt of an input indicating a selection of the one or more options for managing content.

According to a specific embodiment of the present invention, a method of communicating media to one or more RTSP clients using a multimedia terminal is provided. The method includes receiving, at a multimedia exchange server, a request to establish a communication link between the multimedia terminal and the multimedia exchange server and establishing the communication link between the multimedia terminal and the multimedia exchange server. The method also includes receiving, at the multimedia exchange server, a first media stream from the multimedia terminal and transmitting an RTSP media stream from the multimedia exchange server acting as an RTSP-like server. The RTSP media stream is transmitted inside a predetermined time period from receiving the first media stream.

According to another specific embodiment of the present invention, a method of providing an interactive multimedia game to a multimedia terminal in a telecommunication network is provided. The method includes receiving, at a multimedia exchange server, a request to establish a communication link between the multimedia terminal and the multimedia exchange server and establishing the communication link between the multimedia terminal and the multimedia exchange server. The method also includes providing, at the multimedia exchange server, a first media stream to the multimedia terminal. The first media stream is associated with the interactive multimedia game. The method further includes receiving, at the multimedia exchange server, one or more user inputs from the multimedia terminal. The one or more user inputs either control the interactive multimedia game or define a participation in the interactive multimedia game.

According to yet another specific embodiment of the present invention, a method of providing an interactive game to two or more terminals communicating through one or more telecommunication networks is provided. The method includes establishing a first communication link between a first multimedia terminal and a multimedia exchange server and establishing a second communication link between a second multimedia terminal and the multimedia exchange server. The method also includes receiving, at the multimedia exchange server, a first media stream from the first multimedia terminal and receiving, at the multimedia exchange server, a second media stream from the second multimedia terminal. The method further includes transmitting, from the multimedia exchange server, a first game media stream to the first multimedia terminal and transmitting, from the multimedia exchange server, a second game media stream to the first multimedia terminal.

Many benefits are achieved by way of the present invention over conventional techniques. For example, embodiments of the present invention provide for storing and modification of multimedia information communicated over 3G telephone networks. In a particular embodiment, a 3G telephone connects to a server by dialing a telephone number and transmits an audio/video message to the server, which then stores and processes the message for delivery to a second user. Depending upon the embodiment, one or more of these benefits, as well as other benefits, may be achieved. The objects, features, and advantages of the present invention, which to the best of our knowledge are novel, are set forth with particularity in the appended claims. The present invention, both as to its organization and manner of operation, together with further objects and advantages, may best be understood by reference to the following description, taken in connection with the accompanying drawings.

### BRIEF DESCRIPTION OF THE DRAWINGS

FIG. 1 is a simplified schematic diagram of a multimedia exchange architecture according to an embodiment of the present invention.

FIG. 2 is a simplified schematic diagram of service architecture scenarios according to an embodiment of the present invention;

FIG. 3 is a simplified flowchart illustrating a method of communicating media using a 3G terminal according to an embodiment of the present invention; and

FIG. 4 is a simplified flowchart illustrating a method of transmitting media from a wireless video terminal and an IP-based video sharing portal according to an embodiment of the present invention;

FIG. 5 is simplified flowchart illustrating a method of transmitting media and meta-information to an IP-based video sharing portal according to an embodiment of the present invention;

FIG. 6 is a simplified flowchart illustrating such a method of managing media on a multimedia exchange server according to an embodiment of the present invention; and

FIG. 7 is a simplified flowchart illustrating a method of providing an interactive multimedia game to a 3G terminal in a telecommunication network according to an embodiment of the present invention.

### DETAILED DESCRIPTION OF SPECIFIC EMBODIMENTS

The selection of circuit versus packet access is governed by a variety of issues, including cost, quality of service (QoS), quality of experience (QoE), billing, and service availability. This invention relates to a method and apparatus that makes access to multimedia seamless from the user perspective. Embodiments of the present invention have many potential applications, for example and without limitations, residential, enterprise or carrier gateways for multimedia surveillance and security, access to personal multimedia libraries, personal multimedia diaries, multimedia message boards, peer-to-peer and multi-peer gaming, and the like.

In a 3G-324M environment, interaction between terminal endpoints and the intervening network can be classified into three areas: call signaling, session signaling, and media exchange. Call signaling is used to set up the bearer channel between endpoints. In 3G-324M, the bearer channel is typically a 64 kbits/sec channel.

Session signaling is used to define the framing used on the bearer channel, to negotiate media options, to create, identify, and control the operation of “logical channels” (which carry the media) within the multiplexed frames on the bearer, and to communicate control information between endpoints (such as the carriage of user key-presses).

3G operators and service providers may offer their videotelephony subscribers equipped with 3G-324M terminals access to enhanced services (such as videoconferencing and videomail). They may also offer the subscribers the option of reaching users on other networks (such as the public internet or corporate packet networks) and to establish videotelephony and conferencing sessions with them. In order to offer such services, the operators and services providers generally equip their networks with gateways that can provide protocol translation between the 3G terminals (i.e., 3G-324M) and the protocols of the services and/or users in the other networks. For example one protocol for multimedia communication that is used on the packet networks (e.g., public internet or corporate packet networks) is the ITU-T H.323 protocol. Other example protocols are the IETF (Internet Engineering Task Force) Session Initiation Protocol (SIP), Real-Time Streaming Protocol (RTSP), and Hyper Text Transfer Protocol (HTTP). H.323, SIP, RTSP, and HTTP are packet-switched protocols that are widely used for service connectivity whether for conversational multimedia communication or multimedia information access such as streaming. Many protocols are derived from or share many features with other protocols. To denote this similarity we use the suffix “-like”, so that 3G-324M is considered H.324-like and SIP/IMS is considered SIP-like. Likewise for other variants or revisions so that RTSP v2 is considered RTSP-like.

The translation between protocols (e.g., between 3G-324M terminals and H.323, SIP, RTSP, HTTP terminals or services) is typically done by a gateway function. The gateway converts the protocols including signaling, session establishment, media, as well as transport between circuit- and packet-switched networks, in order to bridge subscribers on a network with services and/or subscribers on other networks.

There are many examples and applications of the ability to exchange multimedia information in real-time without requiring terminals to store information locally, but instead storing information through an off-terminal process (e.g., remote or network storage mediated by a server). For instance, a user may want to share a multimedia experience (e.g., a music concert, an excerpt in the middle of a sport game) with some friends, but does not want to call (or could not call) the friends directly. The service will allow the user to connect (e.g., by making a video call) to the multimedia exchange server and to record or store the content on the server. The user may instruct the server to call the friends and to communicate the MM (Multimedia) information to them. Hence the service could be considered as a “message board,” a weblog (or “blog”), a multimedia “diary,” or a multimedia store that can be shared by multiple users. Such a service may provide many value added services. These value added services may include one or more of the following:

Programmable alarm (e.g., timed message or live content) delivery. This could be for a user to be called back by the service at a specific time/event to deliver a multimedia message.

Group broadcast. To broadcast a multimedia message to a group of predefined users.

Group share. To enable the ability to share multimedia content with users that have access rights such as a Caller ID, a password, or other authentication schemes.

Defining Access Control facilities to the user so multimedia content access privileges can be defined.

Defining digital rights management of created content to control multimedia distribution (redistribution).

Presence service such as service presence or user presence monitoring.

Content modification and manipulation. The ability to modify and manipulate multimedia content through editing facilities. Operations could include appending content to other content, deleting sections of content, inserting section of content, amongst others.

Content server that can provide content in conferencing situations. Ability to have the content streamed to participants in a conference, or to have a conference of participants recorded for later review.

Content re-interpretation or conversion (e.g., recognition of voice into text).

Content delivery in various formats such as 3G-324M calls, video conferencing, MMS (Multimedia Messaging Service), SMS (Short Message Service), emails, and other formats.

Content archiving and metadata addition for archive, rapid search and indexing purposes.

Watermarked content delivery and archiving where watermarks could be predefined or custom defined (e.g., by the means of DTMF) for content marking for archiving purpose or for services such greeting videos.

Addition of meta information, or tagging is provided is some embodiments. Such meta information includes, without limitation, either keywords, descriptions, or additional information pertinent to the media such as subtitles or additional information regarding the location of a device at a time of capture/transmission (e.g., Location Based Services information, GPS coordinates/longitude/latitude/altitude or a wireless access point identifier such as a cell identifier or a wireless LANs location or even its IP address that can be used with additional services to retrieve a location).

Security monitoring applications where a sensor with multimedia communication capability could connect to the service and transmit a video to be recorded, following the detection of an intrusion event, on a time based, or under instruction.

Content overlay to allow desired information such as video overlaying with user inputs, instant messages, emails, pictures and subtitles converted from voice recognition for live and/or offline sharing.

Peer-to-peer and multi-peer gaming, where terminals on the same or different networks can participate in games where a multi-media exchange architecture not only relays the gaming information but also video and audio and other auxiliary information which introduce presence and allow participants to observe each other. An example would be a game of chess between two players that is centrally managed at the multimedia exchange server, providing the game media and a rendering of the state of the chess board. The participants in the game would also be able to observe their opponents video, as well as converse in real time in the audio. For a handset with limited input capabilities the MEA will map the controls to the game such that, for example, 2,4,6,8 are respectively up, left, right and down with the 5 button being select. For chess controls selecting the pieces could be controlled by moving a selection indicator, rendered on screen, such as a perimeter highlight, onto the piece with 2,4,6,8 and pressing 5 to select it, then moving into a new position again with 2,4,6,8 and selecting the final position with 5. Many puzzle games would have similar controls and variants would exist.

Subscription services where users can request to be informed on a specific type of event/events in real-time or near real-time.

Subscription services where users can request to be informed on a specific type of information based on their possible changing location information are provided herein. For example, transmitting media of restaurant information (or advertisement/special) or tourist or event information when traveling through a city near to a place of interest may be performed. The architecture also could employ network capabilities to provide a service based on some tagged information so that when a user enters a particular location, then information is transmitted. For example, in a geo-caching game, clues may be provided upon entering into a cell, offering further clues to the next location of interest.

Multiple different users making calls into an exchange server could be automatically categorized as attending the same specific event based on time and location information. For example, if a mobile base station is deployed, or a fixed base station already exists at a venue for an event, for example a field concert or a sporting event, then all the transmissions to an exchange server (or exchange server cloud) could automatically be categorized and tagged on the server as being for that event. This tagging could be applied to the personal, privately available content to save individual tagging effort, or each recognized message could be made publicly available. Using this service, an event organizer could provide a number or address and users could deposit messages/media to that number, thereby chronicling the day with accurate time and location information by simply transmitting. This could then easily be provided for playback by event attendees after the event.

Sousveillance, from the French “sous”=below instead of “sur”=above in surveillance, is enabled by this service, allowing for personal experience capture along with an ability to gamer more power to a group of people that typically would have lost out to surveillance technologies. The technology could also be used in order to allow active contribution of citizens in policing such minor infractions as traffic incidents and possibly further involvement in providing evidence for other crimes. The use of temporally predictive video might limit this application however, as some jurisdictions do not admit compressed video as evidence. The service also offers an additional ability to news network allowing “crowdsourcing” whereby news media feeds are not provided by the new networks own camera crews, but instead by people already on the scene with video capable devices. The media sourced in this manner could then possibly be paid for with conventional means, or micro-credits, or simply by tagging the clips with the supplier.

The service, including these exemplary services, can be delivered in various ways. One way is through an architecture that consists of a videotelephony gateway terminating videotelephony calls and bridging the call to a multimedia server. The gateway effectively serves as a simple mechanism to extract the multimedia streams (in addition to call control information) and to store them, possibly in a way that it can simplify its sharing and access to it. One possible way to store the information could be through a 3GPP file format. Other formats are possible as well. The multimedia server would also have facilities to initiate connections to other users or other services in a programmed, predetermined, or predefined fashion or in an ad-hoc or “real-time” way, and to deliver the multimedia content to users or servers, or to record multimedia information (e.g., call-back service).

The architecture described above is one of many possible ways of delivering services. Other architectures may combine the gateway and the server (server terminates the calls), or the server may be distributed further in functionality. Some approaches may be more attractive in some respects including cost, configurability, scalability, interfacing with existing network components and system, and the like.

Embodiments of the present invention provide a service that allows users to efficiently share multimedia information. The transmission of multimedia information to servers for recording purposes is a basic desirable function and can be achieved in various ways.

One way is to record locally and transmit a file to others in a manner similar to the operation of MMS. Another approach is to record locally and transfer by normal email to others. Another approach is not to record locally (or partially record locally for buffering reasons) and to connect to a Multimedia Exchange Server (MES) and stream to the MES in real time or in “near” real-time (e.g., with some delays). Obviously the way the multimedia information is streamed would depend on the protocol used. For example, and without limiting embodiments of the present invention, the streaming may be done over a video call (e.g., videotelephony (VT)) over an appropriate network such as 3G. In this example, the 3G-324M protocol may be used over a circuit-switched connection. In some embodiments, this approach is referred to as VT Exchange. It will be noted that alternative approaches are also possible. An example is to use the packet switched service in a simple Internet framework or in an IP Multimedia Subsystem (IMS) framework.

The VT Exchange approach has some attractions in that users are accustomed to “making calls.” A simpler user experience means faster acceptance and adoption/uptake of the service.

Regardless of the protocol or transport technologies used, the user can perform functions such as recording, playing/replaying, replacing, deleting, forwarding, sharing (manipulating white-list or access control) multimedia information, combinations of these, and the like. According to embodiments of the present invention, all these functions are performed by using a handset or terminal for remote control.

In the case of VT Exchange, control by handsets can be done in band (e.g., data over dedicated logical channel, standard signals or messages), out of band, or a combination. Control information can be communicated, for example, using Dual Tone Multi Frequency (DTMF) or user input indications (UII) possibly over a control if it is available (e.g., H.245). The use of short-codes, or DTMF appended to called numbers, may be used for rapid access to the service. With the proper facilities, a user may be able to respond to a multimedia message by immediately recording or including one or several multimedia clips.

Embodiments of the present invention provide many advantages related to the streaming of content over video calls (with streaming possible to and from the exchange server). Depending on the embodiment, these advantages may include no need for local storage and hence no restriction or question of running out of memory/flash disk space; access can be controlled by a password or access list (e.g., white-list); and local memory can be “freed” from such activity and clips can be shared with others at any time by simply adding somebody to a white-list or providing them with a password. Additional advantages may include the processing and/or manipulation of content on the fly (during playback or during recording at system ingest) if desired, for example, by applying a watermark, or giving the content a theme, or using an avatar; content can be trans-sized (video frame size changed); and content can be transrated (video frame rate and/or bit rate changed); content can be transcoded on the fly (in real-time during playback). Further advantages may include an enhanced probability of users being able to access the content since most 3G mobile terminals and video-calling terminals on the internet today and future can make video calls; and when a multimedia protocol such as 3G-324M (circuit-switched) is used, bit-rate efficiencies may be achieved compared to protocols such as the internet protocol as packet overheads are reduced. This is an important advantage in situations where the up-link (user to network) bit-rate is limited.

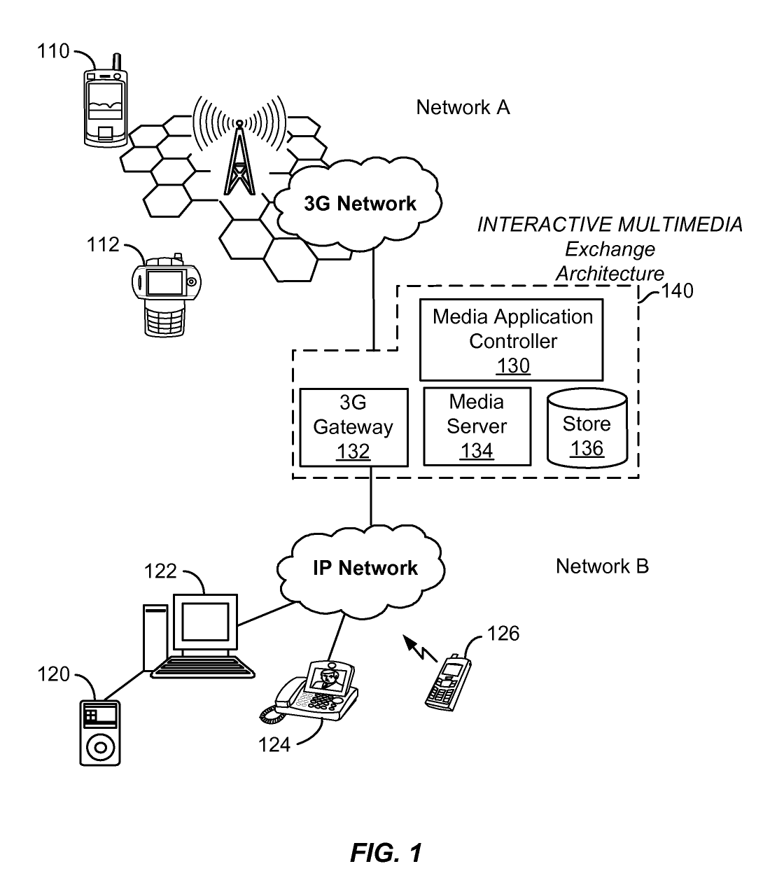

FIG. 1 is a simplified schematic diagram of a multimedia exchange architecture according to an embodiment of the present invention. As illustrated in FIG. 1, embodiments of the present invention provide a network and architecture solution for multimedia exchange. Without limitation or loss of generalization, we show two networks A and B. As illustrated, network A is a 3G network, which is described as circuit switched telephony technology but may also be 3G packet switched, and Network B is an Internet Protocol (IP) network that is not cellular (i.e., no standard roaming or handover or fall over as traditionally known in cellular networks). For purposes of clarity, only major functions provided by the illustrated architecture are shown. As illustrated in FIG. 1, the video gateway 132 bridges different protocols/networks/codecs and the Media Server 134 implements the multimedia exchange function.

Subscribers on Network A or Network B can connect to the Multimedia Exchange Architecture (MEA) 140 in a manner similar to dialing a service. One or more users can connect at the same time to either the same session if so desired, or to different sessions. In an embodiment, terminal 100 is a 3G-324M terminal and terminal 112 is an IMS terminal, both of which are connected to Network A, which is a 3G network. In the illustrated embodiment, terminal 120 is an iPod® connected to computer 122, terminal 124 is an IP terminal, and terminal 126 is a IP terminal such as a WiFi or WiMax terminal. Computer 122, terminal 124, and terminal 126 are connected to Network B, which is an IP network in this example. Other embodiments employ other terminals as appropriate to the particular networks.

The call is routed to the MEA 140, which may transmit a greeting message and an interactive selection menu. The selection menu could be fixed or programmable through a provisioning system (e.g., through a WEB portal), this provisioning could be performed by a service operator, the user, or in concert. The selection menu may be triggered on demand. The menu may be programmed in a scripted language for interactive response, such as VXML/VoiceXML (including video extensions), and may be created dynamically. A user may select a task (e.g., to record a multimedia message) by selecting the appropriate menu (e.g., DTMF or voice for use with Interactive Voice Response—IVR). The MEA may transmit a confirmation and some signal to inform the user that the task has started. Alternatively the task could be selected by allocating a special dial number (e.g., short code), hence reducing the inputs the user has to provide to perform a task.

For example, in the context of a message recording, the user would start recording, directing the handset camera to what they would like to have recorded. The user may at any time stop recording, rewind, and start recording again, or delete frames. Other functions such as over-writing recorded voice/audio, and/or video, and/or data are also possible. The user may also replay what has been recorded, delete the message, forward the message to other subscribers or other MEA, set the property of the message (life-time, access-list/white-list, and the like), or upload the message to a media sharing/distribution facility such as Google Video, YouTube, Yahoo Video, Friendster, Facebook, or MySpace. For example, in the case of distributing the video through Google Video or similar services, the MEA would have an interface to communicate with the Google Video server and would upload the video using a specific login account and could optionally provide additional meta information as well. The user may also allow other subscribers or other MEAs to receive the multimedia being recorded in real-time and/or near real-time (with some delay). The user may perform more advanced functions such as modifying the media, adding text, or even combining media (i.e., adding a theme, or other background music, or adding an image or movie backdrop and even adding two recorded images to be put together in some fashion such as picture in picture). The user may also start recording a new message and repeat the procedure.

Further media information may be recorded by the MEA 140, or requested by the MEA from a terminal, the network or another mediation device. Examples of useful meta-data to associate with a recording may include recording/publishing time and geographical or network specific information. The description above is not limited by the underlying network or transport architecture being used.

Other tasks provided by the multimedia exchange architecture may include functions such as games (one-, two- or multi-peer), and facilities for distribution of greetings or announcements. Operators and service providers can use this service for network announcements (net outages) or for advertisement and shopping purposes.

Once provided as a part of a commercial service, the multimedia exchange could be billed in various ways. Some billing systems may be more attractive than others because only minor or no changes may be required to adapt existing billing systems. For instance, users may be more used to being billed by the calls or sessions, in which case billing by the session, or session duration could be appropriate. In the case of a charge by call/session, the charge would be a single one-time charge for the session, regardless of its duration. In the case of a session duration charge, the call/session record could be used to determine the time duration of the session, and it is then charged accordingly.

Another charging model is that of a flat rate, in which the user is billed for a periodic access fee (e.g., monthly) during which time period the user might have unlimited or “fair use” limited access to the service.

Another charging model would be to charged dependent only on the deposited or retrieved media, whereby a charge may be incurred for each single item deposited/retrieved, or the size of the items, or possibly the quality(codecs used, or other attributes) of the item, or any combination of all of the above. Further charges may be levied based on additional processing performed on the media. The billing may further be affected by choices on the phone to transmit media using high, normal or low quality settings to manually minimise charges. Alternatively, the service may negotiate different quality settings and bandwidth rates based on a number being called. For example, a premium number might allow high quality deposits (or retrieval) and a non-premium or free-call number might allow minimal quality. So for example, if a premium number is dialled, then the exchange server uses a high quality codec in its negotiations, such as H.264 capability in its H.245 TCS or SIP SDP, and if a non-premium number is used then a lesser quality codec is used such as H.263 (even though the exchange server might include support for the better codec, it would not offer it). Alternatively, or in concert with codec selection, the premium service may offer a higher bit rate. Also, the codec selected might be modified in session based on interactions with the menu, so for example selecting a premium option might re-negotiate the codec to be used for the media deposit or retrieval.

Pre-paid service is another approach to charging, by which a user may buy service access to deposit video content, and the retrieval may be either charged differently or may be free.

Many combinations may exist, in that the deposit service may be charged and the retrieval service may be free, or the reverse, or both may be chargeable. The overall access (deposit and retrieval) may also be free, if it is part of a service bundle or if the desired revenue for the service provider is achieved indirectly (e.g., advertisements, a particular example is advertisements transmitted at the start of a message deposit or retrieval and/or through video ringback tone), or as a limited promotional offer period.

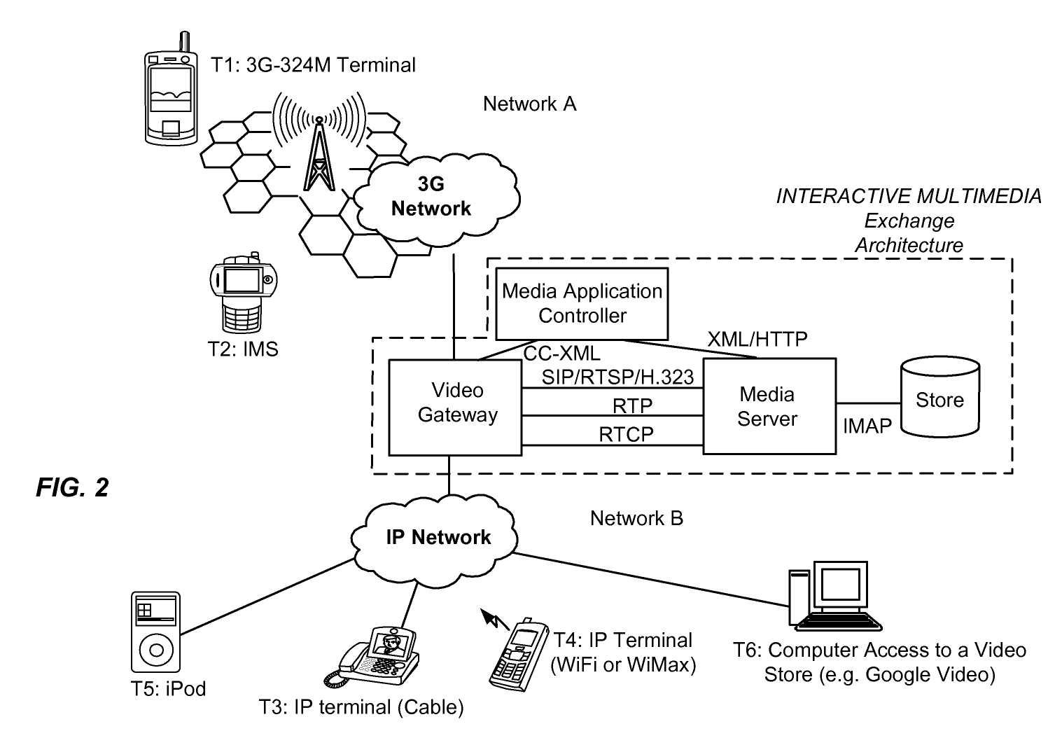

FIG. 2 is a simplified schematic diagram of service architecture scenarios according to an embodiment of the present invention. Without loss of generality, we illustrate in the examples described herein the scenarios where a user deposits a video content through a 3G videotelephony (VT) access means. Obviously, the user could deposit the content through other means, in particular a packet connectivity protocol such as SIP, H.323, HTTP, Push to Show (IMS based SIP), RTSP (via RECORD), a proprietary protocol, a future generation multimedia communication protocol, or the like.

The examples used here illustrate the numerous ways that content, once deposited, can be accessed or received by another user. In addition to the numerous ways of depositing content, embodiments of the present invention provide for the reverse process, in which the relevant access terminals are equipped with means to capture multimedia (audio, video and data). The interconnection protocol between T1 and the 3G network is 3G-324M (over a circuit-switched network). A user dials a call to the MEA (through the Mobile Network infrastructure). Through number analysis or other means, the call is directed to a gateway which treats the call as an MEA call. The gateway establishes a session with a media application controller, which provides instructions back to the gateway in terms of connecting to a media server. The gateway uses the instructions provided by the media application controller, and establishes a session to the media server, which in turn receives the content from the terminal (T1) through the mobile network and the gateway, and stores it in the store in a format (e.g., 3GPP format, Microsoft Media Format, and the like) suitable for retrieval, play back, mixing, management, or modification.

Similarly, if the instruction received from the terminal (e.g., T1) is to forward or share a media content with another subscriber, the user at T1 would enter an instruction through the keypad (e.g., DTMF) which is relayed to the media application controller, which in turn converts the instruction into a second instruction through the gateway (or directly to the media server), the instruction conversion being to convert the received DTMF/UII into either a new DTMF/UII understood by the media server, or a known message, or a proprietary message, for the media server to call the subscriber to receive the published content. The media server, based on the connection to be established with the subscriber, will then take the appropriate action. The appropriate actions include, but are not limited to the following:

If the subscriber is on mobile network (e.g., T2) that can receive video calls, then the media controller could call out this subscriber and play a greeting and then offer to the subscriber to see the video. This dial out publishing is a push method that may be subscribed to. After receiving the content, the user may be given several options to reply or interact to the content as appropriate. For example, to directly reply to the message with media or to tag the received media with a comment (either via audio or text, or speech recognized audio converted to text).

If the subscriber is on a network that cannot receive video calls (or is provisioned to not receive video calls), the media server could transfer the media to the subscriber using an appropriate alternative protocol through, for example:
a call using a packet call (e.g., push to show or a simple packet call using SIP/IMS or H.323, or
instructing the terminal of the subscriber to establish an RTSP session to the media server, or
simply pushing the media to the terminal via FTP or another protocol for transfer, or
emailing or sending MMS the content to the subscriber, or
informing the user if desired of the availability of the media (e.g., via paging, voicemail, SMS or email) and the user would download the content via a protocol such as FTP, HTTP, or an equivalent protocol, or
publishing the media to a web page served from the MEA or another server to which the MEA pushes content. The MEA or podcast server can transcode the content to a suitable format for distribution, or
publishing the media to a podcast/RSS feed served from the MEA or another server to which the MEA pushes content. The MEA or podcast server can transcode the content to a suitable format for distribution, and prepare the feed details based on content, meta information and possible interaction and pre-provisioning. The feeds could then be accessed via podcast reading software for download to portable devices, or
publishing the media to a public, semi-public, or private video Blogging or video distribution facility such as Google Video (video.google.com) or the Google Video Store.

Depending on the user terminal or client device, the display of the content could be performed using a download and play or immediate streaming and play, regardless of the underlying transport of the media. For example the media could be downloaded to a media device such as an Apple iPod (see, for example, T5 in FIG. 2) and, depending on the device, audio, video, auxiliary information, or their combination can be played. Another example is the uploading (e.g., by the MEA) of the video content under the instruction of the user to an online video store (or video blogging service) such as the Google Video portal, from which the video can be distributed according to the facilities of the online store, and can be viewed using a terminal connected to the internet, for example, T6 in FIG. 2). The video portal itself may be or may incorporate an MEA.

The media exchange service could be used to establish a community of users who can produce, share and modify the content. The community could be managed by a user or by the service provider. The extent of the service is limited by what the provider is willing to provision, and would obviously depend on the billing model of the service—i.e., flat billing model versus metered billing model according to the amount of information transmitted or the duration of the transmission.

The media exchange service could be used for access to a personal multimedia library, which may be network stored either in a private user network, or SAN or from a hosted accessible storage service such as Amazon S3 or even from a streaming service such as Real Network's Rhapsody or Apple's iTunes. The media, which may contain a person's entire media collection, could then be made available across multiple devices and transcoded if required depending on the access technology and device characteristics allowing device agnostic access to owned media at anytime where connectivity allows.

The media exchange service could be used for automatically adding information, such as audio or internationalized audio or text, to an HTML page rendered through the MES as a proxy. In this case, a call would be made to an HTTP server, via an MES proxy (possibly through a short code, but also from a portal interaction). The MES proxy may automatically augment the web page (which may contain very little media other than an image of the screen) with additional media such as audio prompts. For example, a login screen, either tagged with markup language or automatically detected from its features or content, would allow for a message to say please login in an internationalized manner, that is in multiple languages, based on location information, preference information, or localization information, without needing it to be programmed explicitly in the web site.

The media exchange service could be used as various other proxies allowing access to disparate networks. For example, the MES can act as an HTTP Proxy, RTSP Proxy, and RTP Proxy. An example of operation would be a call going to the proxy allowing for HTTP viewing, or depositing. Also of interest is a conversion of protocols that allows for RTSP streaming broadcast on the internet from a video phone. In this application, a 3G phone could make a video call to a number for the MES, which automatically starts an RTSP (RTP) stream on a public or private internet of the possibly converted content in real time. Thus embodiments allow for real-time display of the content being captured at the phone on any number of internet devices, and even 3G videophones connected to the RTSP source. This would be useful for journalism, sharing with friends and for real estate agents and sales people desiring to display certain features in real time to a larger (possibly anonymous) audience.

An example podcast/RSS feed for the Multimedia Exchange Server is shown in the following XML code.

```
<?xml version=“1.0” encoding=“UTF-8”?>
<rss xmlns:itunes=“http://www.itunes.com/DTDs/Podcast-1.0.dtd”
xmlns:media=“http://search.yahoo.com/mrss”
xmlns:geo=“http://www.w3.org/2003/01/geo/wgs84_pos#”
xmlns:feedburner=“http://rssnamespace.org/feedburner/ext/1.0” version=“2.0”>
  <channel>
  <title>Multimedia Exchange podcast</title>
  <description>Multimedia Exchange podcast for Brody Kenrick.</description>
  <link>http://vtexchange.dilith.com</link>
  <copyright>Dilithium Networks Pty Ltd</copyright>
  <language>en-au</language>
  <itunes:category xmlns:itunes=“http://www.itunes.com/dtds/podcast-1.0.dtd”
text=“Comedy”/>
  <itunes:explicit xmlns:itunes=“http://www.itunes.com/dtds/podcast-
1.0.dtd”>No</itunes:explicit>
  <itunes:summary xmlns:itunes=“http://www.itunes.com/dtds/podcast-1.0.dtd”>Multimedia
Exchange personal podcast.</itunes:summary>
  <itunes:subtitle xmlns:itunes=“http://www.itunes.com/dtds/podcast-1.0.dtd”>Brody Kenrick
personal Multimedia Exchange</itunes:subtitle>
  <itunes:author xmlns:itunes=“http://www.itunes.com/dtds/podcast-1.0.dtd”>Brody
Kenrick</itunes:author>
  <itunes:owner xmlns:itunes=“http://www.itunes.com/dtds/podcast-1.0.dtd”>
    <itunes:email>noemail@noemail.com</itunes:email>
    <itunes:name>Brody Kenrick</itunes:name>
  </itunes:owner>
  <itunes:image xmlns:itunes=“http://www.itunes.com/dtds/podcast-1.0.dtd”
href=“http://vtexchange.dilith.com/podcasting/images/vtexchange300×300.jpg”/>
  <itunes:keywords xmlns:itunes=“http://www.itunes.com/dtds/podcast-
1.0.dtd”></itunes:keywords>
  <geo:lat>-25.345267</geo:lat>
  <geo:long>131.035566</geo:long>
  <image>
    <link>http://vtexchange.dilith.com</link>
    <url>http://vtexchange.dilith.com/podcasting/images/vtexchange144×89.jpg</url>
    <title>Multimedia Exchange</title>
  </image>
  <item>
    <title>VTExchange 2 Jan 2006 - 162124</title>
    <itunes:author>Brody Kenrick</itunes:author>
    <description>Multimedia Exchange published material</description>
    <enclosure url=“http://vtexchange.dilith.com/podcasting/media/02Jan06_162124.mp4”
length=“” type=“video/mov”/>
    <guid
isPermaLink=“false”>http://vtexchange.dilith.com/podcasting/media/02Jan06_162124.mp4</guid>
    <pubDate>Mon, 02 January 2006 16:21:24</pubDate>
    <itunes:explicit>no</itunes:explicit>
    <itunes:duration>00:01:43</itunes:duration>
    <itunes:keywords></itunes:keywords>
    <author>noemail@noemail.org</author>
    <media:content url=“http://vtexchange.dilith.com/podcasting/media/02Jan06_162124.mp4”
type=“video/mov”>
    <media:adult scheme=“urn:simple”>nonadult</media:adult>
    </media:content>
    <itunes:explicit xmlns:itunes=“http://www.itunes.com/dtds/podcast-
1.0.dtd”>No</itunes:explicit>
    <itunes:subtitle xmlns:itunes=“http://www.itunes.com/dtds/podcast-1.0.dtd”>Multimedia
Exchange</itunes:subtitle>
    <itunes:author xmlns:itunes=“http://www.itunes.com/dtds/podcast-1.0.dtd”>Brody
Kenrick</itunes:author>
    <itunes:summary xmlns:itunes=“http://www.itunes.com/dtds/podcast-1.0.dtd”>Multimedia
Exchange.</itunes:summary>
    <itunes:keywords xmlns:itunes=“http://www.itunes.com/dtds/podcast-
1.0.dtd”></itunes:keywords>
    <link>http://vtexchange.dilith.com/podcasting?m=20060102_162124</link>
<feedburner:origLink>http://vtexchange.dilith.com/podcasting/media/02Jan06_162124.mp4</feedburner:origLink>
  </item>
  <item>
  <title>VTExchange 2 Jan 2006 - 162837</title>
  <itunes:author>Brody Kenrick</itunes:author>
  <description>Multimedia Exchange published material</description>
  <enclosure url=“http://vtexchange.dilith.com/podcasting/media/02Jan06_162837.mp4”
length=“” type=“video/mov”/>
  <guid
isPermaLink=“false”>http://vtexchange.dilith.com/podcasting/media/02Jan06_162837.mp4</guid>
  <pubDate>Mon, 02 January 2006 16:28:37</pubDate>
  <itunes:explicit>no</itunes:explicit>
  <itunes:duration>00:00:56</itunes:duration>
  <itunes:keywords></itunes:keywords>
  <author>noemail@noemail.org</author>
  <media:content url=“http://vtexchange.dilith.com/podcasting/media/02Jan06_162837.mp4”
type=“video/mov”>
    <media:adult scheme=“urn:simple”>nonadult</media:adult>
  </media:content>
  <itunes:explicit xmlns:itunes=“http://www.itunes.com/dtds/podcast-
1.0.dtd”>No</itunes:explicit>
  <itunes:subtitle xmlns:itunes=“http://www.itunes.com/dtds/podcast-1.0.dtd”>Multimedia
Exchange</itunes:subtitle>
  <itunes:author xmlns:itunes=“http://www.itunes.com/dtds/podcast-1.0.dtd”>Brody
Kenrick</itunes:author>
  <itunes:summary xmlns:itunes=“http://www.itunes.com/dtds/podcast-1.0.dtd”>Multimedia
Exchange.</itunes:summary>
  <itunes:keywords xmlns:itunes=“http://www.itunes.com/dtds/podcast-
1.0.dtd”></itunes:keywords>
  <link>http://vtexchange.dilith.com/podcasting?m=20060102_162837</link>
<feedburner:origLink>http://vtexchange.dilith.com/podcasting/media/02Jan06_162837.mp4</feedburner:origLink>
  </item>
  </channel>
</rss>
```

All the details included in the feed could be automatically updated upon “publishing” content. As shown in the example above, details may include media attributes, authorship and copyright indications, such things as geographical location, which could be recorded by the terminal either by GPS (Global Positioning System) or LBS (Location Based Systems) or another mechanism, or by the network's LBS, publishing date, or a still image to be displayed representing the media that may be extracted from the media sequence.

Another example embodiment of the multimedia exchange architecture is where peer-to-peer gaming incorporates audio/visual presence of participants. In this case the participants could be in the same network (e.g., 3G) on different networks utilizing same or different access methods (circuit-switched or packet-switched). The multimedia exchange architecture not only relays the gaming information exchanged by the terminals of the participants (humans or machine with automated gaming) but would also incorporate audio and video information that can be transported either as part of the game data (in-band) or out-of-band through a normal video telephony calls. The mode of transport of the real-time audio-visual information can be circuit-switched (e.g., 3G-324M) as it would provide better response (lower latency) in present networks.

The architecture of the embodiment can be similar to that of the XML code shown above. Note in this case the terminals (handsets) may simply be video telephones with optionally some gaming extensions, or they could be conventional (unmodified) video phones with the gaming information completely transmitted over the audio, video and/or data channels by the multimedia exchange architecture. The phones may also support some toolbox capabilities to support the games while not requiring specific support for the game. The toolbox may incorporate the ability to download additional features and extensions to support a game. Some terminals not equipped with multimedia communication (e.g., can only download and play) may not participate in the game, but may be able to get a recording of the games or may also be able to participate in the game in a non-real time manner.

Depending on the type of terminals used, the users may participate in the game using key presses (e.g., DTMF) or a special device added to the terminal such as a stick or stylus or touch sensitive screens. The interpretation of the user input (e.g., key presses) can be done in the media server which maps them to the visual and gaming experience to be achieved in response to the user input.

The multimedia exchange architecture in this context not only receives the multimedia information from the terminals but can mix additional information depending on the game. The distribution of the multimedia information to the terminals of the participants can be performed by the media server and/or by the video gateway with a mixing and distribution capability.

Referring once again to FIGS. 1 and 2, a multimedia exchange server provided in some embodiments is capable of communicating multimedia information from a first terminal to a second terminal. The multimedia exchange server, sometimes referred to as a multimedia exchange architecture, includes a multimedia gateway (e.g., a 3G multimedia gateway) adapted to receive a first media from a first network and transmit a second media to a second network. The networks may be circuit switched networks, such as the 3G network illustrated, or a packet switched networks. The networks may employ or utilize various protocols, including, without limitation, 3G-324M, SIP, SIP/IMS, H.323, H.324, HTTP, or RTSP. As discussed throughout the present specification, related or -like protocols are also included within the scope of these embodiments.

The multimedia exchange server also includes a processor (also referred to as a media server) coupled to the multimedia gateway and adapted to provide the second media, and a memory coupled to the processor and adapted to store the first media. The first media is stored in the memory for a predetermined period of time, which is greater than a buffering period, for example 10 seconds or longer.

The media server is capable of publishing the media stored in the memory to one or more devices coupled to the second network, for example devices 120, 124, and 126. The buffering period may be measured in seconds or referenced to the duration of the media depending on the application. Providing the second media may include at least one of copying the first media, appending data to the first media, or modifying the first media as appropriate to the second network. Additionally, providing the second media may include modifying the first media as appropriate to the second network by utilizing at least one of a transcoding process, a transizing process, or a transrating process.

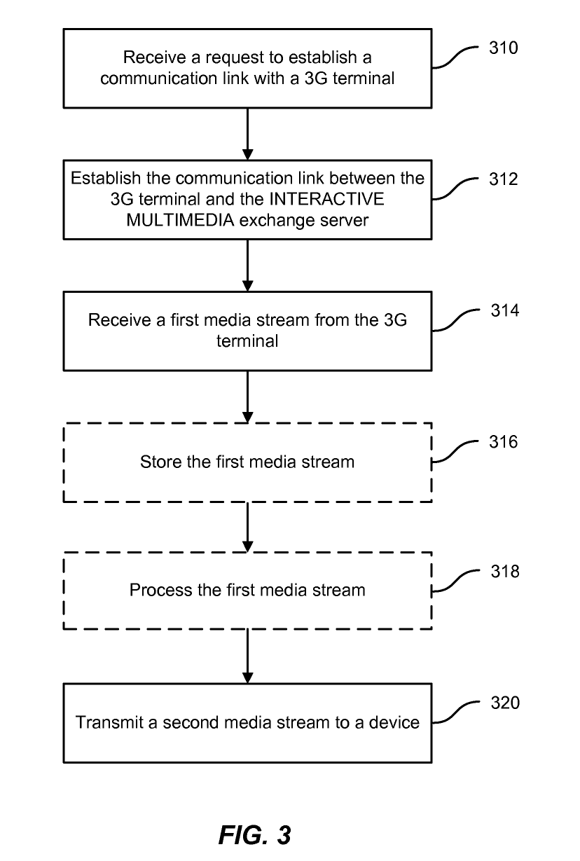

FIG. 3 is a simplified flowchart of a method of communicating media using a 3G terminal according to an embodiment of the present invention. Referring to FIG. 3, the method includes receiving, at a multimedia exchange server, a request to establish a communication link between a 3G terminal and the multimedia exchange server (310) and establishing the communication link between the 3G terminal and the multimedia exchange server (312). The 3G terminal may be a 3G phone, a 3G server, a 3G gateway, or other 3G devices. Establishing the communication link includes initiating a 3G call utilizing a 3G-324M protocol in some embodiments. As discussed above, the multimedia exchange server may be associated with a telephone number, facilitating ease of connection. Multiple subscribers may connect to the multimedia exchange server concurrently.

The method also includes receiving, at the multimedia exchange server, a first media stream from the 3G terminal (314). Merely by way of example, the first media stream may be provided through a 3G call utilizing the 3G-324M protocol. Optionally, the first media stream is stored (316) and processed (318) at the multimedia server. Storage of the first media stream may be performed using one or more memories as illustrated by Store 136 in FIG. 1. Processing of the first media stream at the multimedia exchange server may be performed to provide a second media stream. Generally, processing includes at least one of a transcoding process, a transizing process, or a transrating process. The optional processing and storing steps may be performed with processing prior to storage or processing after storage. As an example, in a sharing application, the second media stream is transmitted at a predetermined time after the first media stream is stored in the one or more memories of the multimedia exchange server. Thus, embodiments of the present invention provide methods and systems are suitable for delayed distribution, sharing applications, and the like. One of ordinary skill in the art would recognize many variations, modifications, and alternatives.

In some applications, the first media stream is received at the multimedia exchange server in real-time or near real-time. Thus, embodiments of the present invention provides for media sharing without requiring storage of the media at the originating device, beyond any buffering associated with media as normally used in the protocol. In a particular embodiment, the first media stream is transmitted from the 3G terminal to the multimedia exchange server prior to completion of a 3G terminal capture process associated with an end of the first media stream. Thus, the transmission of the first media stream is begun prior to the end of the process of capturing the first media stream, for example, a video clip 10 seconds long. Accordingly, in this example, the transmission of the first media stream from the 3G terminal to the multimedia exchange server will begin in less than 10 seconds from the beginning of the capture process.

For example, in 3G-324M, the media is transmitted with less than 150 ms of delay to avoid impacting conversational quality, with some terminals buffering by less than 50 ms. Near real-time could be any value above 500 ms, but would still have transmission before the capture of the entire file. The first media stream may include audio, video, images, data, combinations thereof, and the like.

The method further includes transmitting a second media stream from the multimedia exchange server to a device (320). As an example, the device may be a portable media player, a personal computer, a computer server, or the like. In addition to transmission of the second media stream to the device, the second media stream may be transmitted to one or more additional 3G terminals. In some applications, the method of communicating media using a 3G terminal additionally includes receiving a synchronization request from the portable media player and transmitting the second media stream from the multimedia exchange server to the portable media player in response to the synchronization request.

In some embodiments, the device is a computer server adapted to publish contributed media clips. A user account associated with the computer server can be determined based on information associated with the 3G terminal. As an example, a users Google Video account details, Myspace login, or Youtube registration. The user account may be mapped from a calling party number associated with the 3G terminal. So for example, the telephone number of the calling/depositing party could be looked up in a table or database to determine the login details required to submit media associated with the user on the computer server.

As another example, the second media stream may be transmitted after an occurrence of one or more events have occurred. These events include completion of the reception of the first media stream, reception of a publish command from the 3G terminal, or a request from the device.

In an embodiment, a capture process associated with a frame of media is completed and the transmission of a frame of media from the 3G terminal to the multimedia exchange server is initiated within a predetermined time period after completing the capture process. As an example the predetermined time period may be less than or equal to 500 ms, less than or equal to 150 ms, or less than or equal to 50 ms. Alternatively, the media transmission of the first media stream from the 3G terminal to the multimedia exchange server may be started before the completion of the capture process associated with the first media stream.

Embodiments of the present invention provide for the transmission of one or more pieces of meta-information associated with the 3G terminal from the 3G terminal to the multimedia exchange server. The meta-information may be a variety of information related to the 3G terminal, for example, location meta-information associated with a physical location of the 3G terminal, provided, for example, by a GPS receiver associated with the 3G terminal. In cellular applications, the location meta-information may be provided by a telecommunications network coupled to the 3G terminal. Thus, the geographical location of the 3G terminal may be transmitted to the multimedia exchange server and utilized during the call. In an application, the one or more pieces of meta-information are received from a telecommunications network coupled to the 3G terminal.

In addition to location information, the meta-information may include keywords, sometimes referred to as tags. Examples of meta-information include, without limitation, either keywords, descriptions, or additional information pertinent to the media such as subtitles or additional information regarding the location of a device at a time of capture/transmission. Location information, also referred to as Location Based Services information may include GPS coordinates, longitude, latitude, altitude, combinations thereof. For some systems, a wireless access point identifier such as a cell identifier or a wireless LANs location may be provided as meta-information regarding the call. In some embodiments, the IP address of a device can be used with additional services to retrieve a location of the device.

Embodiments of the present invention provide for the transmission of a menu from the multimedia exchange server to the 3G terminal. The menu may be a series of nested menus and may include options for recording a clip, publishing a clip, deleting a clip, or modifying a clip.

The menu may be presented to the user in a variety of formats, for example, audio information, video information, both audio and video information, and the like. Based on the menu options, the use of the 3G terminal may provide one or more inputs to the multimedia exchange server and the multimedia exchange server responds to the inputs as appropriate to the particular application. As an example, a user may provide inputs based on the menus by pressing one or more keys and/or buttons on the 3G terminal. Generally, pressing one or more keys and/or buttons results in the transmission of either a number of DTMF messages or a number of UII messages from the 3G terminal to the multimedia exchange server.

It should be appreciated that the specific steps illustrated in FIG. 3 provide a particular method of communicating media using a 3G terminal according to an embodiment of the present invention. Other sequences of steps may also be performed according to alternative embodiments. For example, alternative embodiments of the present invention may perform the steps outlined above in a different order. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize many variations, modifications, and alternatives.

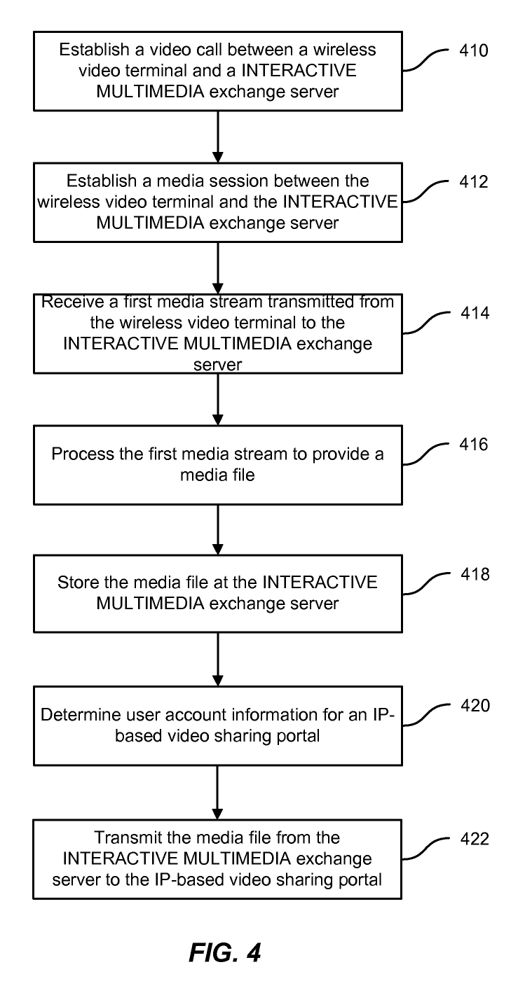

FIG. 4 is a simplified flowchart illustrating a method of transmitting media from a wireless video terminal and an IP-based video sharing portal according to an embodiment of the present invention. In an embodiment, the method identifies a user sharing media from a wireless video terminal to an IP-based video sharing portal. The method includes establishing a video call between a wireless video terminal and a multimedia exchange server (410) and establishing a media session between the wireless video terminal and the multimedia exchange server (412). A first media stream is transmitted from the wireless video terminal and received at the multimedia exchange server (414). The first media stream is processed at the multimedia exchange server to provide a media file suitable for an IP-based video sharing portal (416). Processing of the first media stream may include performing at least one of a transcoding process, a transizing process, or a transrating process. In other embodiments, other processing functions are performed as appropriate to the particular application. One of ordinary skill in the art would recognize many variations, modifications, and alternatives.

The media file is stored at the multimedia exchange server (418) in one or more memories provided therein. In order to prepare for transmission of the media file to the IP-based video sharing portal, user account information for the IP-based video sharing portal is determined based in part on one or more characteristics of the video call (420). As an example, the user account information may be determined based on a calling party identifier associated with the wireless video terminal. The media file is transmitted from the multimedia exchange server to the IP-based video sharing portal utilizing the user account information (422).

It should be appreciated that the specific steps illustrated in FIG. 4 provide a particular method of transmitting media from a wireless video terminal and an IP-based video sharing portal according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

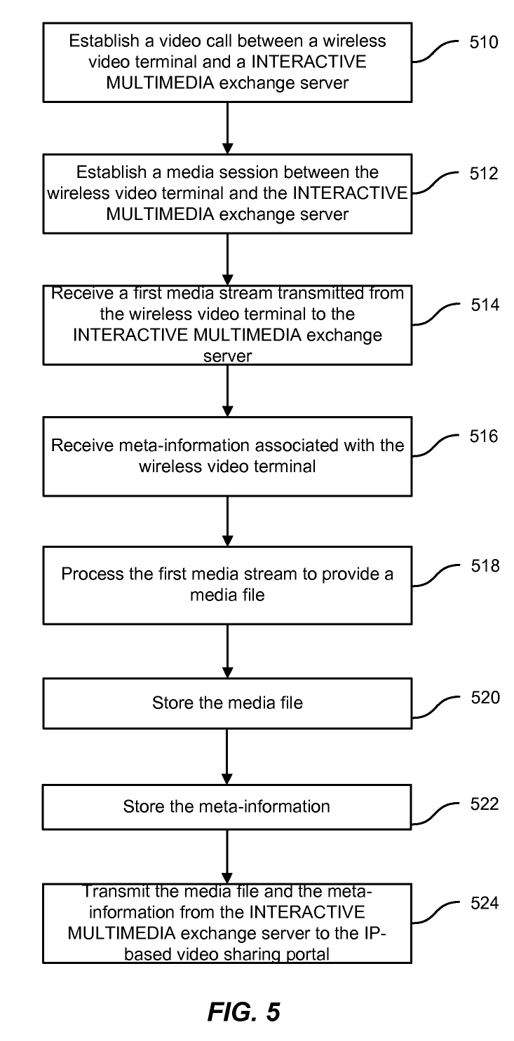

FIG. 5 is simplified flowchart illustrating a method of transmitting media and meta-information to an IP-based video sharing portal according to an embodiment of the present invention. As illustrated in FIG. 5, embodiments of the present invention provide methods and systems that can tag media received from a wireless video terminal, for example, with information related to the location of the wireless video terminal. Accordingly, both media shared by a user of the wireless video terminal and meta-information associated with the wireless video terminal are provided to the IP-based video sharing portal.

A video call is established between a wireless video terminal and a multimedia exchange server (510) and a media session is established between the wireless video terminal and the multimedia exchange server (512). A first media stream is transmitted from the wireless video terminal and received at the multimedia exchange server (514). Additionally, one or more pieces of meta-information associated with the wireless video terminal are received at the multimedia exchange server (516). The meta-information may include information such as LBS information, GPS coordinates, longitude and latitude, longitude, latitude and altitude, cell information, wireless hotspot identification, user tags, user ID, calling party identifier, called party identifier, a place identifier, an event identifier, and/or a temporal indication.

The first media stream is processed at the multimedia exchange server to provide a media file suitable for the IP-based video sharing portal (518). Processing of the first media stream may include transizing (e.g., adjusting the size to something suitable for the service, or devices using the service), transrating (e.g., modifying the bitrate for the access technology or device capabilities) and transcoding (e.g., modifying the content coding type for device capability or for licensing reasons) as well as supplying additional meta-information and possibly Digital Rights Management (DRM) and encryption. It should also be noted that the processing may provide more than one media file suitable for different users of the service. Further processing not necessarily directly associated with suitability for the system, may be applied for user desired effects, such as sepia tones or applied themes.

The media file (520) and the one or more pieces of meta-information (522) are stored at the multimedia exchange server in one or more memories disposed therein. The multimedia exchange server or the IP-based video sharing portal may be collocated. The media file and the one or more pieces of meta-information are transmitted from the multimedia exchange server to the IP-based video sharing portal (524). In some embodiments, transferring the media file includes performing a file transfer operation.

The meta-information may include a number of different types of information. For example, the meta-information may be LBS information, GPS coordinates, latitude, longitude, latitude and longitude, latitude and altitude, cell information, wireless hotspot information, user tags, a user ID, a calling party identifier, a called party identifier, a place identifier, an event identifier, or a temporal indication. The meta-information is not limited to this list, but may include other information related to the call or the media.

In an embodiment, the meta-information, for example, location information, is used to identify the media file as a previously stored media file. Merely by way of example, the meta-information may relate to an event that occurred at a specific time at a particular location. The event may be used in a presentation of the previously stored media file on an event specific web site or a portal.

It should be appreciated that the specific steps illustrated in FIG. 5 provide a particular method of transmitting media and meta-information to an IP-based video sharing portal according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

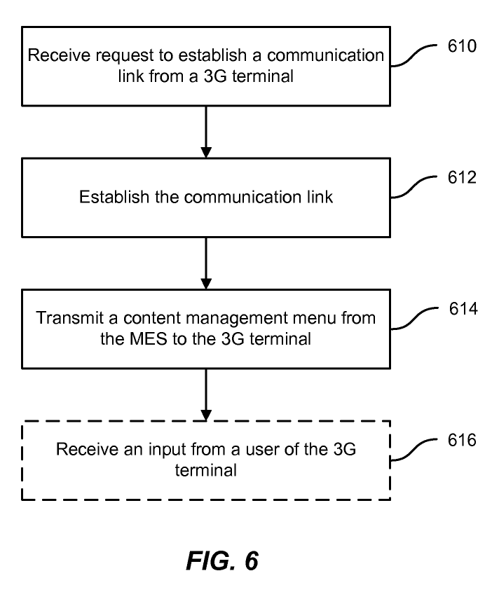

Some embodiments of the present invention provide methods and systems for managing media on a multimedia exchange server using a 3G terminal. FIG. 6 is a simplified flowchart illustrating such a method of managing media on a multimedia exchange server according to an embodiment of the present invention. The method includes receiving, at a multimedia exchange server, a request to establish a communication link between the 3G terminal and the multimedia exchange server (610). A link is established (612) between the 3G terminal and the multimedia exchange server. The method also includes transmitting a content management menu from the multimedia exchange server to the 3G terminal (614). In some embodiments, the content management menu includes audio information, video information, data, combinations thereof, and the like. The content management menu includes one or more options for managing content on the multimedia exchange server. Additionally, the multimedia exchange server is adapted to respond to a receipt of an input indicating a selection of the one or more options for managing content as shown in optional step 616.

As an example, the content management menu may include one or more options for recording a clip, publishing a clip, deleting a clip, or modifying a clip. By entering an input (e.g., by pressing one or more keys on the 3G terminal that result in the generation of one or more DTMF messages or one or more UII messages), the user of the 3G terminal is able to select one or more of the options and thereby manage the media stored on the multimedia exchange server. For instance, modifying the clip may include creating an association between the clip and one or more pieces of meta-information. It may also include processing the clip to form a new clip. Moreover, publishing the clip may include making the clip available publicly or privately on one or more services or making the clip available via a 3G-324M streaming service or an RSS feed.

It should be appreciated that the specific steps illustrated in FIG. 6 provide a particular method of managing media on a multimedia exchange server according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

In some embodiments, a method of communicating media to one or more RTSP clients using a 3G terminal (e.g., a 3G-324M handset) is provided. The method includes receiving, at a multimedia exchange server, a request to establish a communication link between the 3G terminal and the multimedia exchange server, establishing the communication link between the 3G terminal and the multimedia exchange server, and receiving, at the multimedia exchange server, a first media stream from the 3G terminal. The method also includes transmitting an RTSP media stream from the multimedia exchange server acting as an RTSP-like server. The RTSP media stream is transmitted inside a predetermined time period from receiving the first media stream. The RTSP-like media stream may be transmitted from the multimedia exchange in response to an RTSP-like client connecting to the RTSP-like server or in response to a request received from the 3G terminal.

In an alternative embodiment, the method further includes completing a receive process associated with a frame of media in the first media stream (e.g., a first video frame) and initiating transmission of a frame of media in the RTSP-like media stream (e.g., a second video frame that is a processed version of the first video frame) from the multimedia exchange server within a predetermined time period after completing the receive process.

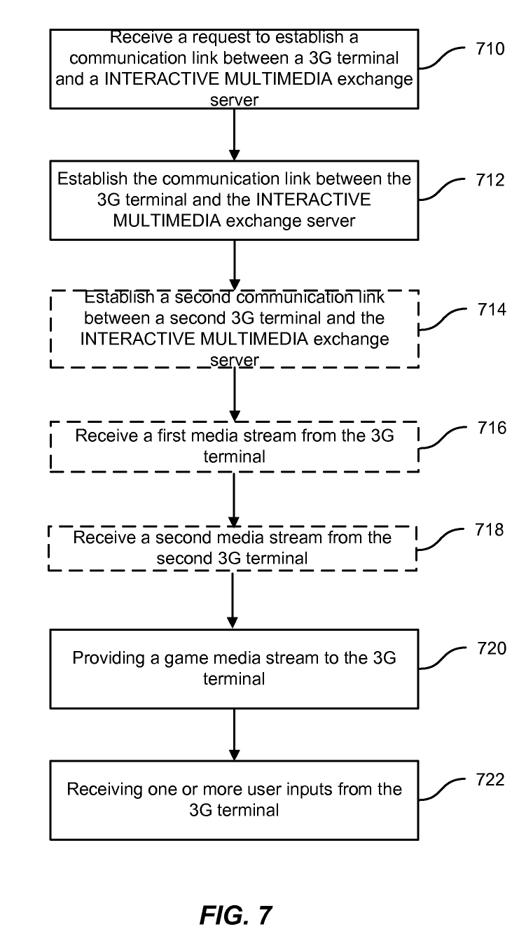

FIG. 7 is a simplified flowchart illustrating a method of providing an interactive multimedia game to a 3G terminal (e.g., a 3G-324M terminal) in a telecommunication network according to an embodiment of the present invention. In a particular embodiment, the 3G terminal is a SIP-like terminal. Embodiments of the present invention provide for the 3G terminal and a corresponding second terminal to be operating on the same telecommunication network or different telecommunications networks. In such applications, the 3G terminal may utilize a first media codec in a first media stream and the corresponding second terminal (e.g., a second 3G terminal) may utilize a second media codec in a second media stream. Generally, the first media codec and the second media codec will be different.

The method includes receiving, at a multimedia exchange server, a request to establish a communication link between the 3G terminal and the multimedia exchange server (710) and establishing the communication link between the 3G terminal and the multimedia exchange server (712). The communication link may include a videotelephony link. The method also includes providing, at the multimedia exchange server, a media stream to the 3G terminal. The media stream is associated with an interactive game. After receiving the media stream, the user may enter one or more user inputs that are transmitted to the multimedia exchange server. The one or more user inputs control the interactive multimedia game or define a participation in the interactive multimedia game. As an example, the one or more user inputs may be one or more H.245 UIIs, in-band DTMF signals, or one or more RFC2833 signals.

The user may enter the inputs using a stylus, a touch sensitive screen, a voice command, a video command, combinations thereof, and the like. The voice command or the video command may be recognized using an automatic recognition procedure. The method may also include transmitting a game media stream to the 3G terminal. Generally, the game media stream will be multimedia mixed from a multimedia source.

In a particular embodiment, the method includes the optional steps of establishing a second communication link between a second 3G terminal and the multimedia exchange server (714), receiving, at the multimedia exchange server, a first media stream from the first 3G terminal (716), and receiving, at the multimedia exchange server, a second media stream from the second 3G terminal (718). In this particular embodiment, multiple game media streams may be transmitted to the 3G terminal. As an example, a first game media stream may include the second media stream, a transcoded version of the second media stream, a combination thereof, and the like.

Embodiments of the present invention provide for real time or near real time interactive games such that the game media stream is transmitted to the 3G terminal within a predetermined period (e.g., less than 500 ms, less than 150 ms, or less than another time) after an associated frame in the second media stream arrives from the second 3G terminal.

Additionally, it is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of communicating media using a multimedia terminal, the method comprising:
receiving, at a multimedia exchange server, a request to establish a communication link between the multimedia terminal and the multimedia exchange server;
establishing the communication link between the multimedia terminal and the multimedia exchange server;
receiving, at the multimedia exchange server, a first media stream from the multimedia terminal;
transmitting a second media stream from the multimedia exchange server to a device;
transmitting an interactive menu from the multimedia exchange server to the multimedia terminal; and
receiving, at the multimedia terminal, one or more user inputs in response to the interactive menu, wherein the multimedia exchange server is responsive to the one or more user inputs.

2. The method of claim 1 wherein the multimedia terminal comprises at least one of a 3G phone, a 3G server, or a 3G gateway.

3. The method of claim 1 wherein the device comprises at least one of a portable media player, a personal computer, or a computer server.

4. The method of claim 1 wherein the device comprises a portable media player.

5. The method of claim 4 further comprising:
receiving a synchronization request from the portable media player; and
transmitting the second media stream from the multimedia exchange server to the portable media player in response to the synchronization request.

6. The method of claim 1 wherein the device comprises a computer server adapted to publish contributed media clips.

7. The method of claim 6 further comprising determining a user account associated with the computer server from information associated with the multimedia terminal.

8. The method of claim 7 further comprising mapping the user account from a calling party number associated with the multimedia terminal.

9. The method of claim 1 wherein establishing the communication link comprises initiating a 3G call utilizing a 3G-324M protocol.

10. The method of claim 1 wherein the first media stream is received at the multimedia exchange server in real-time or near real-time.

11. The method of claim 1 wherein transmission of the first media stream from the multimedia terminal to the multimedia exchange server is initiated before completion of a multimedia terminal capture process associated with an end of the first media stream.

12. The method of claim 1 further comprising:
completing a capture process associated with a frame of media; and
initiating transmission of the frame of media from the multimedia terminal to the multimedia exchange server within a predetermined time period after completing the capture process.

13. The method of claim 12 wherein the predetermined time period is less than or equal to 500 ms.

14. The method of claim 13 wherein the predetermined time period is less than or equal to 150 ms.

15. The method of claim 14 wherein the predetermined time period is less than or equal to 50 ms.

16. The method of claim 14 wherein the first media stream is provided through a 3G call utilizing the 3G-324M protocol.

17. The method of claim 1 further comprising receiving, at the multimedia exchange server, one or more pieces of meta-information associated with the multimedia terminal.

18. The method of claim 17 wherein the one or more pieces of meta-information are transmitted from the multimedia terminal to the multimedia exchange server.

19. The method of claim 17 wherein the one or more pieces of meta-informatiom are received from a telecommunications network coupled to the multimedia terminal.

20. The method of claim 17 wherein one of the one or more pieces of meta-information is a piece of location meta-information associated with a physical location of the multimedia terminal.

21. The method of claim 20 wherein the piece of location meta-information is provided by a GPS receiver associated with the multimedia terminal.

22. The method of claim 20 wherein the piece of location meta-information is provided by a cell identifier provided by a telecommunications network coupled to the multimedia terminal.

23. The method of claim 22 wherein the one or more pieces of meta-information are one or more keywords.

24. The method of claim 1 wherein the multimedia exchange server is associated with a telephone number.

25. The method of claim 1 wherein the multimedia exchange server is accessible by multiple subscribers concurrently.

26. The method of claim 1 wherein the interactive menu comprises one or more options for recording a clip, publishing a clip, deleting a clip, or modifying a clip.

27. The method of claim 1 wherein the interactive menu comprises audio information.

28. The method of claim 1 wherein the interactive menu is associated with a VoiceXML or VXML script.

29. The method of claim 1 wherein the interactive menu comprises video information.

30. The method of claim 1 wherein the interactive menu comprises audio information and video information.

31. The method of claim 1 wherein the one or more user inputs are provided by pressing one or more keys and/or buttons on the multimedia terminal.

32. The method of claim 31 wherein pressing one or more keys and/or buttons provides at least one or more DTMF messages or one or more UII messages.

33. The method of claim 1 further comprising:
storing the first media stream in one or more memories of the multimedia exchange server; and
transmitting the second media stream to one or more additional multimedia terminals.

34. The method of claim 33 wherein transmitting the second media stream is performed at a later time than storing the first media stream.

35. The method of claim 1 wherein the first media stream comprises at least one of audio, video, images, or data.

36. The method of claim 1 wherein the second media stream is transmitted after an occurrence of one or more events selected from the group consisting of completion of reception of the first media stream, reception of a publish command from the multimedia terminal, and a request from the device.

37. The method of claim 1 further comprising processing the first media stream at the multimedia exchange server to provide the second media stream.

38. The method of claim 37 wherein processing the first media stream comprises at least one of a transcoding process, a transizing process, or a transrating process.

39. The method of claim 38 wherein processing the first media stream is performed before a storing process.

40. The method of claim 39 wherein processing the first media stream is performed after a storing process.

41. A multimedia exchange server adapted to communicate multimedia information, the multimedia exchange server comprising:
a multimedia gateway adapted to receive a first media from a first network and transmit a second media to a second network;
a processor coupled to the multimedia gateway and adapted to provide the second media; and
a memory coupled to the processor and adapted to store the first media, wherein the first media is stored in the memory for a predetermined period of time, the predetermined period of time being greater than a buffering period.

42. The multimedia exchange server of claim 41 wherein the multimedia gateway is a 3G multimedia gateway.

43. The multimedia exchange server of claim 41 wherein the processor is adapted to publish the second media stored in the memory to one or more devices coupled to the second network.

44. The multimedia exchange server of claim 41 wherein the buffering period is greater than 10 seconds.

45. The multimedia exchange server of claim 44 wherein the buffering period is greater than 60 seconds.

46. The multimedia exchange server of claim 41 wherein the buffering period is equal to a duration of the first media.

47. The multimedia exchange server of claim 41 wherein the first network is at least one of a 3G network, a circuit switched network, or a packet switched network.

48. The multimedia exchange server of claim 41 wherein the first network is a circuit switched 3G network and the second network is a packet switched network.

49. The multimedia exchange server of claim 41 wherein the first network is a 3G network and the second network is a network employing a protocol selected from the group consisting of 3G-324M, SIP, SIP/IMS, H.323, H.324, HTTP, and RTSP.

50. The multimedia exchange server of claim 41 wherein the first media and the second media are identical.

51. The multimedia exchange server of claim 41 wherein providing the second media comprises at least one of copying the first media, appending data to the first media, or modifying the first media as appropriate to the second network.

52. The multimedia exchange server of claim 41 wherein providing the second media comprises modifying the first media as appropriate to the second network by utilizing at least one of a transcoding process, a transizing process, or a transrating process.

53. A method of communicating media using a 3G-324M terminal, the method comprising:
receiving, at a multimedia exchange server, a request to establish a communication link between the 3G-324M terminal and the multimedia exchange server;
establishing the communication link;
establishing a media session between the 3G-324M terminal and the multimedia exchange server;
receiving, at the multimedia exchange server, a first media stream from the 3G-324M terminal;
transcoding, at the multimedia exchange server, the first media stream to provide a second media stream;
storing, at the multimedia exchange server, the second media stream;
determining, at the multimedia exchange server, that an event has occurred to initiate transmission of the second media stream; and
transmitting the second media stream to a device.

54. The method of claim 53 wherein the device is one of a 3G terminal or a portable media player.

55. The method of claim 54 wherein storing the second media stream and transmitting the second media stream utilize RTSP.

56. The method of claim 53 wherein determining comprises receiving a second request to establish a communication link at the multimedia exchange server.

57. The method of claim 53 wherein determining comprises receiving an HTTP request for a file associated with the second media stream at the multimedia exchange server.

58. The method of claim 53 further comprising making the second media stream available via an HTTP interface.

59. The method of claim 58 wherein making the second media stream available via an HTTP interface comprises making available an RSS feed comprising an URL associated with the second media stream.

60. The method of claim 59 wherein the RSS feed is used in association with a portable media player to transfer the second media stream onto the portable media device.

61. The method of claim 58 wherein making the second media stream available via an HTTP interface comprises making available an HTTP embedded media file associated with the second media stream.
